(19) United States
(12) Patent Application Publication
(10) Pub. No.: US 2001/0026695 A1
(43) Pub. Date: Oct. 4, 2001

(54) Method and apparatus for image forming capable of preventing a contamination of a brush-roller charger

(76) Inventor: Mugijiroh Uno, Kanagawa (JP)

Correspondence Address: Ivan S. Kavrukov, Cooper & Dunham LLP, 1185 Avenue of the Americas, New York, NY, 10036, US

(21) Appl. No.: 09/754,505

(22) Filed: Jan. 4, 2001

(30) Foreign Application Priority Data
Feb. 18, 2000 (JP) 2000-040698

(51) Int. Cl. G03G 15/02

(52) U.S. Cl. 399/50; 399/174; 399/175

(57) ABSTRACT

An image forming apparatus capable of preventing contamination of a brush-roller charger with toner depositions includes a photoconductor, a brush-roller charger, an image development mechanism, an image transfer mechanism, a cleaning mechanism, a power supply mechanism, and a controller. The photoconductor carries an electrostatic latent image thereon. The brush-roller charger rotates in contact with the photoconductor and initializes a surface of the photoconductor by applying a charge thereto. The image development mechanism contacts the surface of the photoconductor and supplies toner to develop a toner image according to the electrostatic latent image on the surface of the photoconductor. The image transfer mechanism transfers the toner image from the photoconductor to a recording sheet. The cleaning mechanism cleans the surface of the photoconductor. The power supply mechanism supplies power to the brush-roller charger. The controller controls the power supply mechanism to stop supplying a voltage to the brush-roller charger for a predetermined time period required for the brush-roller charger to rotate at least one rotation after an image forming operation is finished and before a following image forming operation is started.

### CROSS-REFERENCE TO FORGEING APPLICATIONS

This document claims the priority rights of and is based on the subject matter described in Japanese patent application Nos. JPAP10-310899 filed on Oct. 30, 1998, JPAP10-367293 filed on Dec. 24, 1998, and JPAP11-149980 filed on May 28, 1999, in the Japanese Patent Office, the entire contents of which are hereby incorporated by reference.

### BACKGROUND OF THE INVENTION

1. Field of the Invention

The present invention generally relates to a method and apparatus for image forming, and more particularly to a method and apparatus for image forming which is capable of preventing a contamination of a brush-roller charger with toner depositions.

2. Discussion of the Background

In general, an electrophotographic image forming apparatus forms an electrostatic latent image on an evenly charged photoconductive surface by exposing a part of this surface to light go that a potential of the exposed part is changed. The electrostatic latent image thus formed on the photoconductive surface is developed with toner as a toner image which is then transferred onto a recording sheet.

In such an electrophotographic image forming apparatus, there have been two methods for charging the photoconductive surface; using a non-contact type charger or a contact type charger. The non-contact type charger makes an arc to apply a charge to the surface and is configured to have a distance to the photoconductive surface, while the contact type charger contacts the surface so as to apply a charge directly thereto. Accordingly, the non-contact type charger has more tolerant of contamination by toner particles than the contact type charger. A problem of the non-contact charger, however, is a production of ozone which is not a case for the contact type charger.

A typical contact type charger is a roller charger which rotates in contact with a rotating photoconductive drum, for example. As described above, the roller charger as a contact type charger is prone to be contaminated by the toner particles. FIGS. 1A and 1B illustrates exemplary ways to reduce such a contamination. In FIG. 1A, a cleaner 51 made of material such as a sponge, a felt, or the like is mounted in contact with a roller charger 50 so as to clean the surface of the roller charger 50. In FIG. 1B, a scraper blade 52 made of relatively hard material such as a plastic, or the like is mounted in contact with a roller charger 50 so as to scrape toner depositions off the surface of the roller charger 50.

These cleaning methods shown in FIGS. 1A and 1B, however, fit only for the roller charger which is made of a rubber type roller but not for the one which is made of a brush type roller. That is, the brush type roller charger is elastic at the outer regions thereof and is prone to change a shape of an outer region when the cleaner continues to apply a pressure to the outer region for a relatively long period of time. This happens typically when the image forming apparatus is not in operation and, therefore, the cleaner and the brush-roller charger are held being engaged. As a result, the brush-roller charger decreases in a charging performance.

Another technique has been proposed, in which the brush-roller charger, for example, is applied with a positive or negative voltage and an AC (alternate current) is applied to an image transfer unit for transferring a toner image from the photoconductor to a recording sheet so that the photoconductor discharges. However, this technique requires a high voltage power source which increases a cost of manufacturing.

In the electrophotographic image forming apparatuses using the brush-roller charger, there is a problematic tendency which appears as a relatively high frequency of occurrence of abnormal images made of white dots in a halftone image. The occurrence of abnormal images made of white dots typically increases when the operation is performed in relatively low temperature and humidity after a relatively large number of image forming operations are performed.

Through experiments, Applicant found a fact that the white dot problem described above was mostly caused by a contamination of the brush-roller charger with toner particles. According to an observation by Applicant, extreme fine particles are deposited on the top of brush after a certain number of image forming operations are performed when the white dot problem occurs. Upstream from the brush-roller charger, there is mounted a cleaning unit which sweeps the photoconductor surface clean and, therefore, any particle remaining thereon are extremely fine particles.

The particles deposited on the top of the brush include the particles of toner and silica; the latter is an additive for increasing fluidity of toner. These extremely fine particles of toner and additive generally show a resistance as high as an electrical insulation. On the other hands, the brush is made of a relatively larger number of conductive fibers to which a voltage is applied and which accordingly apply the charge to the photoconductor surface. Therefore, when the brush is covered with the electrical insulating materials such as the particles of toner and silica, the brush may increase its resistance. In addition, such a contamination of the brush with the particles of toner and silica tends to occur in a local spot on the brush-roller surface. This tendency is considered to be attributable mostly to the length and the shape of brush. As a result, the brush-roller charger unevenly charges the photoconductor surface.

As an example, the photoconductor surface usually gains an approximate value of a negative 750-volt with a potential of the brush-roller charger when the brush-roller charger is applied with a negative 1200-volt. In this case, however, the photoconductor surface may have a local spot having an approximate value of a negative 1200-volt when the brush-roller charger is contaminated in the way as mentioned above and accordingly has an uneven resistance. This is caused by an uneven resistance on the surface of the brush-roller charger. An excessive discharge occurs around an area where the resistance is relatively low. An inclusion of fibers having a relatively low resistance may help to increase this excessive discharge.

Under such a circumstance, a sufficient light exposure cannot be made on an area at which an excessive discharge occurs. As a result, a toner image cannot be formed around that area during an image forming operation for generating a halftone image, in particular. In this way, the white dot problem occurs.

### SUMMARY OF THE INVENTION

Accordingly, an object of the present invention is to provide a novel electrophotographic image forming apparatus which is capable of preventing contamination of a brush-roller charger with toner depositions.

Another object is to provide a novel method of electrophotographic image forming which is capable of preventing contamination of a brush-roller charger with toner depositions.

To achieve these and other objects, the present invention provides a novel image forming apparatus which include a photoconductor, a brush-roller charger, an image development mechanism, an image transfer mechanism, a cleaning mechanism, a power supply mechanism, and a controller. The photoconductor carries an electrostatic latent image thereon. The brush-roller charger rotates in contact with the photoconductor and initializes a surface of the photoconductor by applying a charge thereto. The image development mechanism contacts the surface of the photoconductor and supplies toner to develop a toner image according to the electrostatic latent image on the surface of the photoconductor. The image transfer mechanism transfers the toner image from the photoconductor to a recording sheet. The cleaning mechanism cleans the surface of the photoconductor. The power supply mechanism supplies power to the brush-roller charger. The controller controls the power supply mechanism to stop supplying a voltage to the brush-roller charger for a predetermined time period required for the brush-roller charger to rotate at least one rotation after an image forming operation is finished and before a following image forming operation is started.

The brush-roller charger may rotate at a relative line velocity at least 2.4 times faster than the photoconductor.

Also, the present invention provides a method of image forming which includes the steps of providing, applying, forming, supplying, transferring, cleaning, and controlling. The providing step provides a brush-roller charger which rotates in contact with a photoconductor. The applying step applies power to the brush-roller charger so that the brush-roller charger applies a charge to the photoconductor to initialize a surface of the photoconductor. The forming step forms an electrostatic latent image on the surface of the photoconductor. The supplying step supplies toner the surface of the photoconductor to develop a toner image according to the electrostatic latent image on the surface of the photoconductor. The transferring step transfers the toner image from the photoconductor to a recording sheet. The cleaning step cleans the surface of the photoconductor. The controlling step controls the power applying step to stop supplying the power to the brush-roller charger for a predetermined time period required for the brush-roller charger to rotate at least one rotation after an image forming operation is finished and before a following image forming operation is started.

Other objects, features, and advantages of the present invention will become apparent from the following detailed description when read in conjunction with the accompanying drawings.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIGS. 1A and 1B are illustrations for explaining related methods of charging the photoconductor.

FIG. 2 is an illustration explaining a main structure of an electrophotographic image forming apparatus according to an embodiment of the present invention;

FIG. 3 is an illustration for explaining a way of measuring a resistance of a brush-roller charger;

FIG. 4 is an illustration explaining a main structure of another electrophotographic image forming apparatus according to the present invention; and

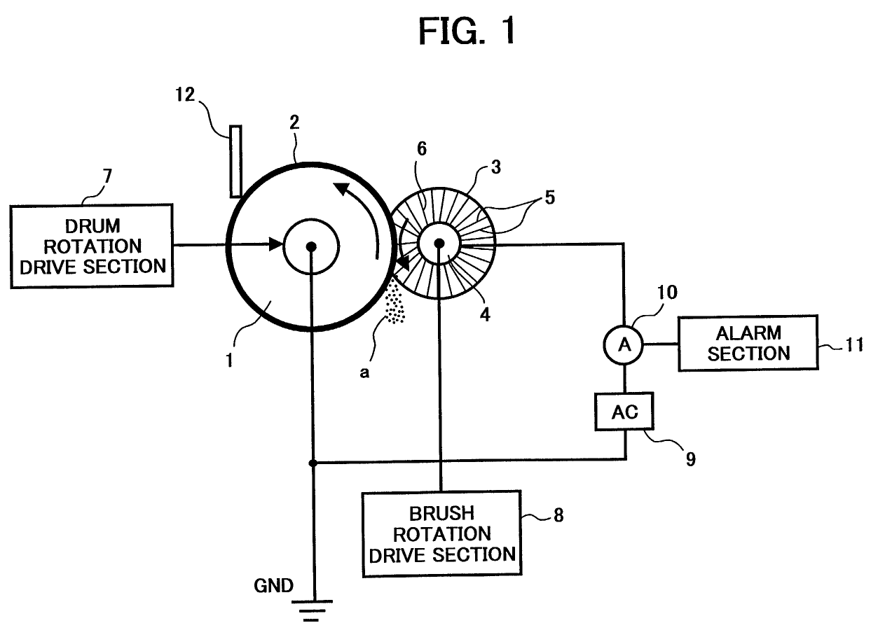

### DESCRIPTION OF THE PREFERRED EMBODIMENTS

In describing preferred embodiments of the present invention illustrated in the drawings, specific terminology is employed for the sake of clarity. However, the present invention is not intended to be limited to the specific terminology so selected and it is to be understood that each specific element includes all technical equivalents which operate in a similar manner.

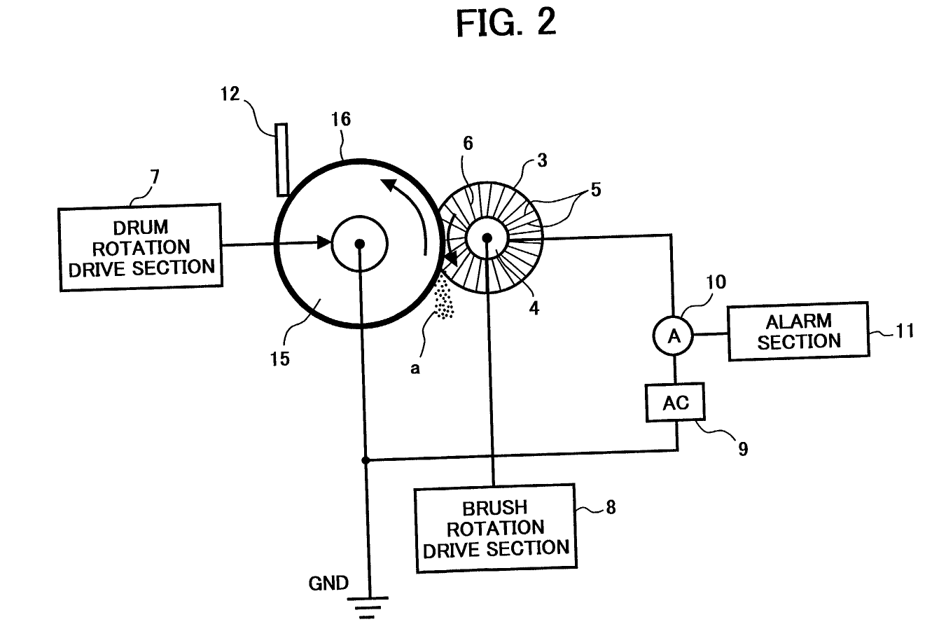

Referring now to the drawings, wherein like reference numerals designate identical or corresponding parts throughout the several views, and more particularly to FIG. 2 thereof, there is partly illustrated an electrophotographic image forming apparatus 100 according to an embodiment of the present invention. In FIG. 2, the electrophotographic image forming apparatus 100 performing an image forming operation in accordance with an electrophotographic method includes a photoconductor 1, a brush-roller charger 2, an optical writing unit 3, an image development unit 4, and an image transfer unit 5. The electrophotographic image forming apparatus 100 further includes an image fixing unit 6, a sheet ejection unit 7, a cleaning unit 8, a sheet input tray 9, and a sheet feed roller 10.

The photoconductor 1 rotates counterclockwise as indicated by an arrow A. The brush-roller charger 2 rotating counterclockwise in contact with the photoconductor 1 initializes the surface of the photoconductor 1 by evenly applying a charge on the surface thereof. The optical writing unit 3 emits light to which the charged surface of the photoconductor 1 is exposed so that an electrostatic latent image is formed thereon. As the photoconductor 1 rotates, the electrostatic latent image thereon passes by the image development unit 4 which then develops the electrostatic latent image with toner. The development unit 4 in this embodiment is a contact type development unit which is mounted in contact with the photoconductor 1.

Thus developed toner image on the photoconductor 1 next passes by the image transfer unit 5 at which the toner image is transferred onto a recording sheet 9a. This recording sheet 9a is included in the sheet input tray 9 and is fed by the sheet feed roller 10 to the image transfer unit 5 so as to receive a toner image on the surface thereof from the photoconductor 1. The recording sheet 9a having the toner image proceeds to the image fixing unit 6 where the toner image is fixed on the recording sheet, and is then ejected outside by the sheet ejection unit 7.

During the above operations, some amounts of toner may not be used by the image development operation by the image development unit 4 and may remain on the photoconductor 1 after the image forming operation. As the photoconductor 1 rotates, the unused toner is collected by the cleaning unit 8 so that the surface of the photoconductor 1 cleaned. Then, the photoconductor 1 is again evenly charged on the surface thereof by the brush-roller charger 2.

The above operations form an approximate cycle of the image forming operation according to the electrophotographic image forming method. By repeating this cycle, a number of image forming operations can successively be achieved.

In this embodiment, a voltage supply to the brush-roller charger 2 is controlled in a way such that the voltage supply to the brush-roller charger 2 is stopped for a predetermined time period required for the brush-roller charger 2 to rotate at least one rotation after an image forming operation is finished and before the next image forming operation is started. After the stop of the voltage supply to the brush-roller charger 2 for such a predetermined time period, the next image forming operation is started,

By periodically providing such a stop of the voltage supply to the brush-roller charger 2, the electrostatic force of the brush-roller charger 2 attracting toner particles is decreasing. In particular, by setting such a predetermined time period to a time required for the brush-roller charger 2 to rotate at least one rotation, the depositions of toner particles on the brush-roller charger 2 can be scrubbed away from the brush-roller charger 2 according to experiments performed by Applicant. As the photoconductor 1 rotates, the scrubbed depositions of toner particles are transferred to the development unit 4 which then collects these depositions. Accordingly, the transferred unit 5 is prevented from contamination by the scrubbed depositions.

Furthermore, the depositions of toner particles on the brush-roller charger 2 can be scrubbed away from the brush-roller charger 2 more efficiently when the photoconductor 1 and the brush-roller charger 2 have a difference in line velocities. An effect of such a scrubbing of the depositions will begin particularly when a ratio of line velocities of the photoconductor 1 and the brush-roller charger 2 is set to a value of 1.4 according to the experiments performed by Applicant. That is, it is preferable to adjust a relative line velocity of the brush-roller charger 2 to a value at least 2.4 times faster than that of the photoconductor 1.

Also, the effect of such a scrubbing of the depositions will efficiently be increased by increasing a depth of engagement of the brush-roller charger 2 relative to the photoconductor 1. In this case, the depth of engagement of the brush-roller charger 2 is preferably adjusted within a range from 0.1 mm to 0.5 mm according to the experiments performed by Applicant. If the depth of such an engagement is excessively large, the brush of the brush-roller charger 2 may permanently change its shape while the brush-roller charger 2 stops rotating.

In addition, the white dots problem described in the background section can be eliminated by adjusting a resistance value of a charge brush of the brush-roller charger 2 within a range from 0.7 MΩ to 4 MΩ. This is because setting the resistance value of the charge brush to a certain value decreases a ratio of inclusion of low resistance fibers in the charge brush. However, if such a resistance value is set to a value greater than 4 MΩ, it may degrade the performance of the primary function for charging the photoconductor 1. Therefore, the resistance value of the charge brush of the brush-roller charger 2 is preferably adjusted to a value smaller than 4 MΩ.

As described above, the depositions can efficiently be removed from the photoconductor 1 when the photoconductor 1 and the brush-roller charger 2 rotate at difference line velocities. In an image forming apparatus in which the photoconductor 1 and the brush-roller charger 2 rotate in directions opposed to each other, a line velocity of the brush-roller charger 2 may preferably be adjusted to a value at least 3.4 times faster than that of the photoconductor 1 so as to set a relative line velocity of the brush-roller charger 2 to a value at least 2.4 times faster than that of the photoconductor 1.

In this way, the electrophotographic image forming apparatus 100 can produce an image in a superior quality without having white dots and dirty dots on the recording sheet.

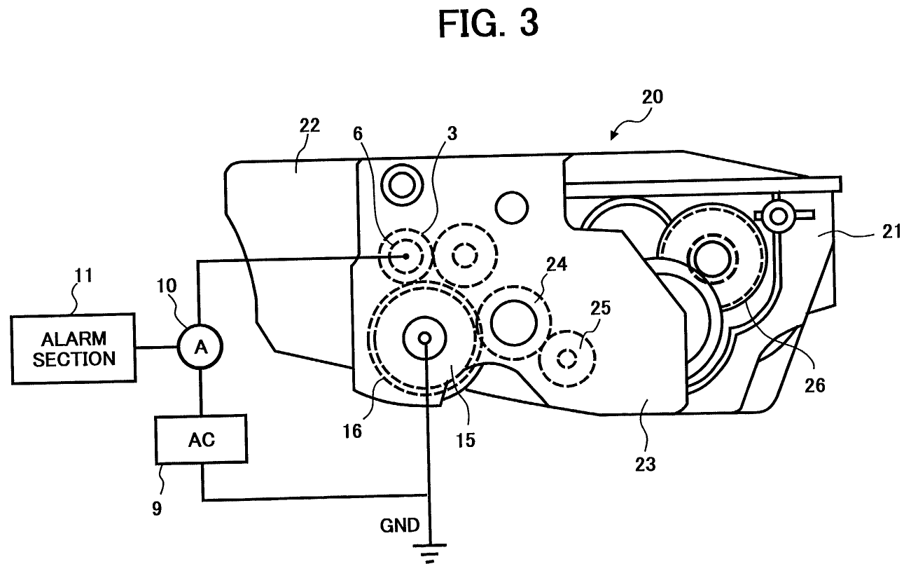

Referring now to FIG. 3, an exemplary way for measuring the above-described resistance value of the charge brush is explained. FIG. 3 illustrates an arrangement for this measurement in which the brush-roller charger 2, a current meter 11, a conductive aluminum drum 12 having a diameter of 24 mm, and a power source 13 are included. In this arrangement, the brush-roller charger 2 having a diameter of 14 mm and a length of 225 mm is engaged with the conductive aluminum drum 12 by a depth of 0.2 mm. The aluminum drum 12 is rotated counterclockwise at a speed of 30 rpm.

After setting this arrangement as shown in FIG. 3, a power (i.e., −100 volts) is applied to a metal axis of the brush-roller charger 2 and a current I (amperes) returning from the aluminum to the power source 13 is measured by the current meter 12. The resistance is then calculated based on the applied voltage V and the current I using the following equation,

R=V/I=100/I. (1)

The diameter of the brush-roller charger 2 is set to 14 mm in the above explanation, however, it is not limited to that value and can be set to any appropriate value. When the brush-roller charger 2 has a length L different from the above case, the resistance is calculated based on the applied voltage V and the current I using the following equation,

R=V/I×22.5/L. (2)

In this case, the current may preferably be measured under the conditions of 25° C. temperature and 60% humidity after the brush-roller charger 2 is laid for 12 hours under the conditions of 25° C. temperature and 60% humidity.

Referring to FIG. 4, another example according to an embodiment of the present invention is explained. FIG. 4 illustrates an electrophotographic image forming apparatus 200 which is similar to the electrophotographic image forming apparatus 100 of FIG. 2, except that the electrophotographic image forming apparatus 200 has no cleaning unit. This is because the recent electrophotographic image forming apparatus is improved in the image transferring operation and, accordingly, most of the toner supplied from the development unit can be transferred to the recording sheet during the image transfer operation and there remains only lesser amount of toner on the photoconductor 1. Therefore, such an electrophotographic image forming apparatus having no cleaning unit has been developed.

In the electrophotographic image forming apparatus 200, a relative line velocity of the brush-roller charger 2 relative to the photoconductor 1, a depth of engagement of the brush-roller charger 2 relative to the photoconductor 1, and a resistance value of the brush-roller charger 2 are set to the values same as those for the electrophotographic image forming apparatus 100 of FIG. 2.

In the thus-arranged electrophotographic image forming apparatus 200, it is possible that toner circumvents the image transferring operation performed by the development unit 4 and remains on the photoconductor 1. However, by periodically providing a stop of the voltage supply to the brush-roller charger 2, the electrostatic force of the brush-roller charger 2 attracting toner particles is decreasing. In particular, by setting such a predetermined time period to a time required for the brush-roller charger 2 to rotate at least one rotation, the depositions of toner particles on the brush-roller charger 2 can be scrubbed away from the brush-roller charger 2 by the photoconductor 1. As the photoconductor 1 rotates, the scrubbed depositions of toner particles are transferred to the development unit 4 which then collects these depositions. Accordingly, the transferred unit 5 is prevented from contamination by the scrubbed depositions. As a result, the electrophotographic image forming apparatus 200 can produce an image in a superior quality without having dirty dots on the recording sheet.

Numerous additional modifications and variations of the present invention are possible in light of the above teachings. It is therefore to be understood that within the scope of the appended claims, the present invention may be practiced otherwise than as specifically described herein.

1. An image forming apparatus, comprising:
a photoconductor configured to carry an electrostatic latent image thereon;
a brush-roller charger which rotates in contact with said photoconductor and configured to initialize a surface of said photoconductor by applying a charge thereto;
an image development mechanism which contacts the surface of said photoconductor and is configured to supply toner to develop a toner image according to said electrostatic latent image carried on the surface of said photoconductor;
an image transfer mechanism configured to transfer said toner image from said photoconductor to a recording sheet;
a cleaning mechanism configured to clean the surface of said photoconductor;
a power supply mechanism configured to supply power to said brush-roller charger; and
a controller configured to control said power supply mechanism to stop supplying a voltage to said brush-roller charger for a predetermined time period required for said brush-roller charger to rotate at least one rotation after a first image forming operation is finished and before a second subsequent image forming operation is started.

2. An image forming apparatus as defined in claim 1, wherein said brush-roller charger rotates at a relative line velocity at least 2.4 times faster than said photoconductor.

3. An image forming apparatus as defined in claim 1, wherein said brush-roller charger is engaged with said photoconductor with a depth of at least about 0.1 mm.

4. An image forming apparatus as defined in claim 1, wherein said brush-roller charger has a resistance within a range from 0.7 MΩ to 4 MΩ.

5. An image forming apparatus, comprising:
a photoconductor configured to carry an electrostatic latent image thereon;
a brush-roller charger which rotates in contact with said photoconductor and configured to initialize a surface of said photoconductor by applying a charge thereto;
an image development mechanism which contacts the surface of said photoconductor and is configured to supply toner to develop a toner image according to said electrostatic latent image on the surface of said photoconductor;
an image transfer mechanism configured to transfer said toner image from said photoconductor to a recording sheet;
a power supply mechanism configured to supply power to said brush-roller charger; and
a controller configured to control said power supply mechanism to stop supplying a voltage to said brush-roller charger for a predetermined time period required for said brush-roller charger to rotate at least one rotation after a first image forming operation is finished and before a second subsequent image forming operation is started.

6. An image forming apparatus as defined in claim 5, wherein said brush-roller charger rotates at a relative line velocity at least 2.4 times faster than said photoconductor.

7. An image forming apparatus as defined in claim 5, wherein said brush-roller charger is engaged with said photoconductor with a depth of at least about 0.1 mm.

8. An image forming apparatus as defined in claim 5, wherein said brush-roller charger has a resistance within a range from 0.7 MΩ to 4 MΩ.

9. An image forming apparatus, comprising:
carrying means for carrying an electrostatic latent image thereon;
rotatable charger means, rotating in contact with said carrying means, for initializing a surface of said carrying means by applying a charge thereto;
toner supply means, contacting the surface of said carrying means, for supplying toner to develop a toner image according to said electrostatic latent image on the surface of said carrying means;
transfer means for transferring said toner image from said carrying means to a recording sheet;
cleaning means for cleaning the surface of said carrying means;
power supply means for supplying power to said rotatable charger means; and
control means for controlling said power supply means to stop supplying a voltage to said rotatable charger means for a predetermined time period required for said rotatable charger means to rotate at least one rotation after a first image forming operation is finished and before a second subsequent image forming operation is started.

10. An image forming apparatus as defined in claim 9, wherein said rotatable charger means rotates at a relative line velocity at least 2.4 times faster than said carrying means.

11. An image forming apparatus as defined in claim 9, wherein said rotatable charger means is engaged with said carrying means with a depth of at least about 0.1 mm.

12. An image forming apparatus as defined in claim 9, wherein said rotatable charger means has a resistance within a range from 0.7 MΩ to 4 MΩ.

13. An image forming apparatus, comprising:
carrying means for carrying an electrostatic latent image thereon;
rotatable charger means, rotating in contact with said carrying means, for initializing a surface of said carrying means by applying a charge thereto;
toner supply means, contacting the surface of said carrying means, for supplying toner to develop a toner image according to said electrostatic latent image on the surface of said carrying means;
transfer means for transferring said toner image from said carrying means to a recording sheet;
power supply means for supplying power to said rotatable charger means; and
control means for controlling said power supply means to stop supplying a voltage to said rotatable charger means for a predetermined time period required for said rotatable charger means to rotate at least one rotation after a first image forming operation is finished and before a second subsequent image forming operation is started.

14. An image forming apparatus as defined in claim 13, wherein said rotatable charger means rotates at a relative line velocity at least 2.4 times faster than said carrying means.

15. An image forming apparatus as defined in claim 13, wherein said rotatable charger means is engaged with said carrying means with a depth of at least about 0.1 mm.

16. An image forming apparatus as defined in claim 13, wherein said rotatable charger means has a resistance within a range from 0.7 MΩ to 4 MΩ.

17. A method of image forming, comprising the steps of:
providing a brush-roller charger which rotates in contact with a photoconductor;
applying power to said brush-roller charger so that said brush-roller charger applies a charge to said photoconductor to initialize a surface of said photoconductor;
forming an electrostatic latent image on the surface of said photoconductor;
supplying toner to the surface of said photoconductor to develop a toner image according to said electrostatic latent image on the surface of said photoconductor;
transferring said toner image from said photoconductor to a recording sheet;
cleaning the surface of said photoconductor; and
controlling said step of power applying to stop applying said power to said brush-roller charger for a predetermined time period required for said brush-roller charger to rotate at least one rotation after a first image forming operation is finished and before a second subsequent image forming operation is started.

18. A method as defined in claim 17, wherein said brush-roller charger rotates at a relative line velocity at least 2.4 times faster than said photoconductor.

19. A method as defined in claim 17, wherein said brush-roller charger is engaged with said photoconductor with a depth of at least about 0.1 mm.

20. A method as defined in claim 17, wherein said brush-roller charger has a resistance within a range from 0.7 MΩ to 4 MΩ.

21. A method of image forming, comprising the steps of:
providing a brush-roller charger which rotates in contact with a photoconductor;
applying power to said brush-roller charger so that said brush-roller charger applies a charge to said photoconductor to initialize a surface of said photoconductor;
forming an electrostatic latent image on the surface of said photoconductor;
supplying toner to the surface of said photoconductor to develop a toner image according to said electrostatic latent image on the surface of said photoconductor;
transferring said toner image from said photoconductor to a recording sheet; and
controlling said step of power applying to stop applying said power to said brush-roller charger for a predetermined time period required for said brush-roller charger to rotate at least one rotation after a first image forming operation is finished and before a second subsequent image forming operation is started.

22. A method as defined in claim 21, wherein said brush-roller charger rotates at a relative line velocity at least 2.4 times faster than said photoconductor.

23. A method as defined in claim 21, wherein said brush-roller charger is engaged with said photoconductor: with a depth of at least about 0.1 mm.

24. A method as defined in claim 21, wherein said brush-roller charger has a resistance within a range from 0.7 MΩ to 4 MΩ.
